(19) United States
(12) Patent Application Publication
(10) Pub. No.: US 2020/0150016 A1
(43) Pub. Date: May 14, 2020

(54) Device for Detecting and Measuring Brake Dust

(71) Applicant: HORIBA Europe GmbH, Darmstadt (DE)

(72) Inventors: Dmytro Logovyy, Grävenwiesbach (DE); Tobias Kurze, Bickenbach (DE); Robert Waninger, Ingolstadt (DE); Sebastian Gramstat, Neuburg (DE)

(21) Appl. No.: 16/609,588

(22) PCT Filed: Apr. 17, 2018
(86) PCT No.: PCT/EP2018/059801

§ 371 Date: Oct. 30, 2019

(30) Foreign Application Priority Data
May 2, 2017 (DE) 10 2017 109 356.7

(51) Int. Cl. G01N 15/02

(52) U.S. Cl. CPC G01N 15/02; G01N 2015/0046

(57) ABSTRACT

The invention relates to a device for measuring and detecting brake dust particles that have been removed from the brake (3). Said device can comprise a particle measuring device (8) for measuring the number of brake dust particles. The particle measuring device (8) can measure the size of the brake dust particles. A removal device (6) for removing or receiving brake dust particles is mounted in an exhaust air duct (10) which conducts an air stream away from a housing (11) surrounding the brake (3). A device (7) is used to guide the brake dust particles from the removal device to the particle measuring device (8). A fan system with a fresh air channel (9) and the exhaust air channel (10) is used to guide an air stream over the brake (3). The device can be an integral component of a brake test level.

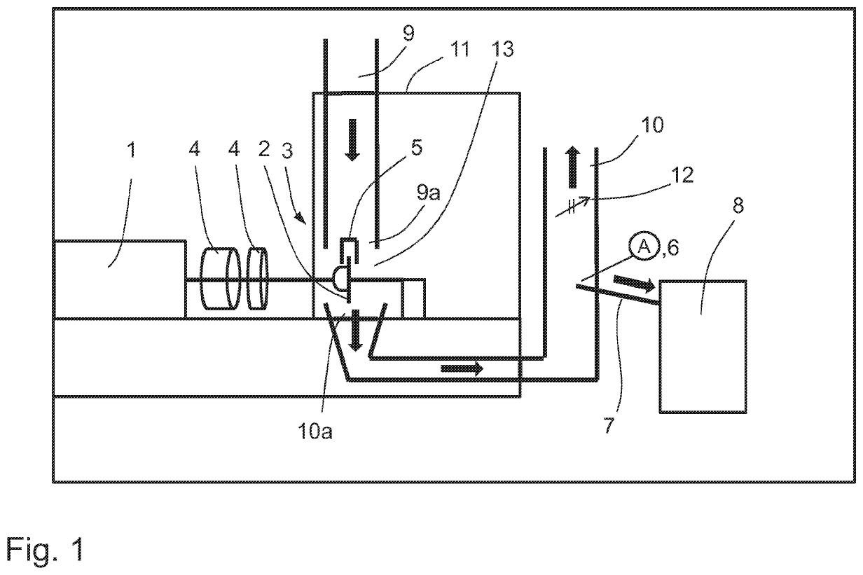

The invention relates to a device for detecting and measuring brake dust, as well as a brake test stand.

Environmental pollution due to vehicle brakes, in particular, car or truck brakes, is a topic that needs to be taken seriously. Due to the braking process within the vehicle, the lining material of the brake linings is abraded in such a manner that finest particles are released due to this process. These are partly even respirable and thus make a harmful contribution to fine dust pollution with corresponding risks for health impairments.

However, in isolation from the serious questions of health impairment due to brake fine dust, brake dust can also cause strong soiling of the wheel rims, which entails at least esthetic disadvantages and can affect the overall appearance of a vehicle.

Currently, there are no measuring devices known to detect and quantify the aforementioned brake dust particles and determine their size.

The invention is therefore based on the object to provide a device for detecting and measuring brake dust.

The invention is solved by a device having the features of claim 1. Advantageous further developments can be taken from the dependent claims.

It is advantageous if the device can already be used at an early stage within the scope of designing the brake system of a vehicle.

Therefore, a measuring device is provided, which is used in the customary, well-known test and development environment for brake systems.

The measuring device for detecting the brake dust functions in connection with a dynamic brake test stand where the brake to be tested is, for example, actuated with, e.g., an electric brake actuator. In this case, the measuring device is part of the overall application and can thus be operated as part of the brake test stand. The measurement of the brake dust particles can be carried out in real time with a plurality of measured values per second.

The measuring procedure suited for this comprises an automated program with defined load cycles applied to the brake system in the brake test stand. That way, brake dust particles can be detected and measured reproducibly in connection with the loads acting on the brake.

The particle behavior of a brake can thus be measured on a brake test stand. Brake test stands are used to simulate the real load profiles of a brake system. These test stands usually provide a stable, reproducible measuring environment for brake testing.

For detecting and measuring the brake particles on the brake test stand, it is possible to define a measuring point. The measuring point can be located within the exhaust air duct of a fan system, which generates a cooling airflow for cooling the brake during the test operation. The brake dust particles are then transported by the airflow to the actual measuring point via the exhaust air duct of the fan system. This measuring point is located at a defined point within the exhaust air duct. There the particles are picked up by the measuring system, e.g. via a hose, a heated hose, or a heated hose with cold air, and guided to the particle measuring device.

The particle measuring device is capable of counting the particles and determining their size and/or size distribution. The device can be a well-known device for measuring small or finest particles, e.g. a device which is used for exhaust gas analysis, e.g. for measuring particles in diesel exhaust gases. Such devices are well-known and are therefore not discussed in further detail at this point.

The particle measuring device can communicate with the brake test stand, so that the measurements are carried out with load profiles synchronized with brake testing. In this way, the measuring results of the particle measuring device can always be allocated to the respective loads of the brake in the brake test stand.

Due to the transport of the brake emissions, in particular, of the brake particles, with the cooling airflow of the exhaust air duct, these are diluted, whereby a homogeneous mix emerges at the same time. The exhaust air duct thus also fulfills the function of a dilution duct or channel. The formation of clumping or conglomerates of the brake dust particles is thereby prevented, which would distort the measuring result and/or would considerably deteriorate the reproducibility of the measurement.

The measuring accuracy can thus be significantly enhanced by the exhaust air duct achieving a dilution effect. Accordingly, the exhaust air duct is to be designed in such a manner that it can reliably achieve the desired dilution effect. Thus, simple discharge of the cooling airflow from the test chamber is not sufficient. Rather, the exhaust air duct should have a dimensioning which enables the dilution effect.

The exhaust air duct can consist of a non-corrosive, electrically conductive material. Where required, the entire exhaust air duct must be heated to prevent formation of a conglomerate of the particles.

The volume flow within the exhaust air duct can be measured with an appropriate volume flow measuring unit.

Together with the measurement of the particles (number, size), the following measuring parameters could be of interest: amount of air, driven kilometers (of the vehicle the brake system of which is currently mounted on the test stand).

Additional parameters such as brake pressure, brake torque, speed and other parameters are recorded by the actual test stand and synchronized with the particle measurement.

After a measurement, the following measured value information should be possible: number of particles per driven kilometers (simulated on the test stand) and size of the particles and/or size distribution in the respective measuring sections of the tested load cycle of the brake testing.

In this way, the brake dust measuring device can be completely integrated into the brake test stand and measured in an automated manner within the scope of a dynamic, realistic load cycle.

Accordingly, the invention relates, in particular, to a device for measuring and detecting brake dust particles detached from a brake, comprising an extraction unit for picking up brake dust particles, a particle measuring unit for measuring the number and/or the size of the brake dust particles, and comprising a conveying unit for guiding and conveying the brake dust particles from the extraction unit to the particle measuring unit. The extraction unit is suited to capture the particles emitted by the brake and convey them onwards.

The conveying unit, e.g. a hose in which an airflow is guided, is suited to transport the particles collected or captured by the extraction unit to the particle measuring unit. It can be reasonably designed and, for example, also include a heatable hose to prevent clumping of the particles.

A brake mount for mounting a brake can be provided. The brake is held and fastened inside the brake mount for test purposes and is itself not part of the measuring device. Rather, the brake is the specimen which is to be examined with the aid of the device.

The extraction unit can be designed in such a manner that it can be arranged in the area of a brake to be mountable in the brake mount, in particular, in the area of a caliper of the brake. In this process, the brake is, as stated above, not a subject of the measuring device. The brake can, for example, be a well-known disc brake for a vehicle, comprising a brake disc and a caliper partly encompassing the brake disc and brake disc [sic!]. The brake is mountable in the brake mount for the test purposes.

The extraction unit can include a collection container with which the brake dust particles can be caught. The collection container can consist of a non-corrosive, electrically conductive material. In the vicinity of the extraction point and/or of the collection container, where the extraction unit picks up the brake dust, additional instruments can be arranged which may, for example, serve to determine the particle mass, the particle size distribution, etc.

The brake mount is encased by a housing impermeable to brake dust particles, whereby a brake mount space is defined. The brake is then fastened in the brake mount within the brake mount space and can be tested.

The housing surrounds the brake mount space and can consist of a non-corrosive, electrically conductive material. The housing is sealed with respect to the surrounding area, so that exclusively air can be supplied to a fan system via a supply air duct described in the following text. In addition, the housing enables that the brake dust particles emitted during the test operation are completely detected. The housing, however, does not serve to dilute or homogenize the brake emissions; these processes rather take place within the exhaust air duct, as described above.

Accordingly, a fan system can be provided, comprising a supply air duct and an exhaust air duct to guide an airflow across the brake. In particular, the supply air duct and the exhaust air duct are coupled to the housing and thus are each connected to the brake mount space to guide an airflow through the brake mount space. In this process, the openings of the supply air duct (outlet of the supply air duct on the housing) and the exhaust air duct (inlet of the exhaust air duct on the housing) can be arranged opposite to the brake mount space within the housing. The openings can be designed in such a manner that their particular opening cross section allows the airflow to flow through the entire brake mount space within the housing. The brake mount is can [sic!] be positioned in such a manner that a brake mounted on it is arranged between the outlet of the supply air duct and the inlet of the exhaust air duct.

The cross sections of the supply air duct and of the exhaust air duct must be defined correspondingly large. For example, the exhaust air duct can be dimensioned in such a manner that its free diameter at its inlet on the housing is not smaller than 70% of the diameter of the brake disc to be tested. Thus, it can be achieved that the airflow fully encompasses the brake and discharges all brake emissions through the inlet of the exhaust air duct.

The airflow serves to guide the brake dust particles, so that the brake dust particles can be reliably detected by the extraction unit within the exhaust air duct, after the brake dust particles have streamed through a specific flow path within the exhaust air duct with a specific length. Similarly, the airflow can also be used for cooling the brake.

The distance between the inlet of the exhaust air duct and of the extraction unit can correspond to at least 5 times, in particular, at least 10 times, in particular, at least 20 times the diameter or the greatest diagonal of the cross section of the exhaust air duct, especially of the cross section of the exhaust air duct downstream of the inlet. A possible funnel shape of the inlet and thus an extension of the cross section at the inlet remains unconsidered for this calculation; the distance is determined by the dimension of the exhaust air duct described below having a substantially constant cross section over a specific section. If the exhaust air duct has a rectangular cross section, the greatest edge length of the rectangle can also be used as a parameter to which the aforementioned conditions will then apply. Thus, it is ensured that the exhaust air duct has a specific length to achieve the desired dilution effect. For example, the length of the exhaust air duct from its inlet to the extraction unit can, for example, amount to at least 100 cm or at least 200 cm.

The distance can, in particular, also be understood as the length of a virtual connection line of the particular main areas of the cross-sectional areas within the exhaust air duct from the inlet to the extraction unit.

Accordingly, the extraction unit can be arranged within the exhaust air duct in such a manner that the flow path of the airflow has a predefined length from the brake to the extraction unit. In particular, the length of the flow path of the airflow and thus the distance between the rotation axis of the brake and the extraction unit can depend on the size of the cross section of the exhaust air duct.

Accordingly, the invention relates, in particular, to a device for measuring and detecting brake dust particles detached from a brake, comprising an extraction unit for picking up brake dust particles, a particle measuring unit for measuring the number and/or the size of the brake dust particles, and comprising a conveying unit for guiding and conveying the brake dust particles from the extraction unit to the particle measuring unit. For this purpose, the extraction unit is arranged within the exhaust air duct, the opening of which is located within the housing of the brake mount space. The brake to be tested is, for the purpose of brake dust particle measurement, surrounded by this housing, and can be supplied with a cooling airflow from a supply air duct through the opening in the housing at an opposite side to the exhaust air duct.

The flow direction of the airflow can be chosen in an appropriate manner. The airflow, for example, can be directed from top to bottom or from bottom to top or in any other manner.

The airflow can be homogenized by flow guidance elements arranged within the supply air duct in order to achieve a homogeneous mix of brake dust particles with (dilution) air.

The fan system can additionally have an air conditioning system, e.g., with inlet filters to purify the air supplied via the supply air duct, and for conditioning the air with regard to temperature and humidity. Furthermore, flow straighteners can be provided. The flow velocity can be controllable at least in relation to the airflow within the exhaust air duct. By conditioning the air, it is achieved that the test conditions for the brake can be largely standardized and reproduced.

Due to the combination of the housing and of the extraction unit provided within the exhaust air duct, complete detection of all particles, which have detached from the brake during the measuring and/or test operation, is possible.

The particle measuring unit can, other than for measuring the brake dust particles, also be suited for exhaust gas analysis, in particular, for measuring particles in diesel exhaust gases. Thus, a device already available on the test stand, e.g., for testing combustion engines, especially diesel engines, can also be used for measuring brake dust.

The particle measuring unit can, for example, have a measuring range of D50=10 nm-2.500 nm.

In this process, the particle measurement can be integrated into the automation software for a brake load unit (e.g. a dynamometer). However, it can also be provided separately from the automation software or function at least without integration into the automation of the dynamometer. However, a synchronization of the particle measurement with the operation of the brake load unit is advisable.

The conveying unit can have one or more pipe or hose-shaped conduits, which can be heated, if required.

In this process, a conduit can connect the extraction unit to the particle measuring unit.

In addition, a brake test stand is provided, comprising a brake mount for mounting a brake to be tested, a driving device for applying a brake load to the brake, measuring units for recording test and measuring parameters of the brake, and comprising a device for detecting brake dust particles, as stated above.

The test and measuring parameters of the brake can be the parameters which are usually relevant for testing a brake. These include the drive performance of the driving device, the brake performance, the reaction torque of the brake, the revolutions per minute, the brake force, the temperature development, vibrations, etc.

The brake dust particle measuring device can be an integral component of the brake test stand, i.e. integrated into the brake test stand. In this manner, the device is always available during the test operation.

The measuring results of the particle measuring unit and the test and measuring parameters of the brake can be correlated with each other, i.e. linked to each other. For example, it can be recorded during which test operation what amount of particles is produced. That way, a correlation between the brake performance, the revolutions per minute, the temperature and the amount and/or size of particles can be produced and documented.

For the correlation of the measuring results and parameters, a corresponding evaluation unit can be provided.

These and additional advantages and features are explained in the following text in more detail with the aid of the FIGURE based on an example. The only FIGURE schematically shows an embodiment for a device for detecting and measuring brake dust particles, which is provided as an integral component of a brake test stand.

The brake test stand in the example shown is designed as a gyrating-mass brake test stand and illustrated in the FIGURE in a schematic view.

A motor 1 serving as a driving engine, e.g. an electric motor, rotatingly drives a brake disc 2 installed in the brake test stand, which is part of the brake 3 to be tested. To stabilize the rotation, gyrating masses 4 can be integrated in a known manner.

The brake disc 2 is partly encased in a known manner by a caliper 5 also belonging to the brake 3 to be tested. The caliper 5 holds the brake linings not illustrated in the FIGURE, which are subject to wear and tear when the brake 3 is actuated, whereby the (fine) particles to be detected are detached from the brake linings.

The brake 3 is installed in a not shown brake mount holding the brake and its components and ensuring a stable support of the brake torques in the brake test stand. The set-up of such a brake mount in brake test stands is sufficiently known so that any additional description is unnecessary.

In the example shown in the FIGURE, also a fan system is provided, comprising a supply air duct 9 with an outlet 9a and an exhaust air duct 10 with an inlet 10a. The supply air duct 9 supplies—via its outlet 9a—air into a housing 11 which encases the brake 3 serving as a specimen and is impermeable to brake dust particles. The exhaust air duct 10 discharges this air from the housing 11 again via its inlet 10a. Thus, the housing 11 encases a brake mount space 13.

A measuring point for an air volume flow measurement can be provided within the exhaust air duct 10, e.g. at reference numeral 12.

Usually, the fan system exists in brake test stands in order to ensure good ventilation of the brake, especially for cooling purposes.

The air supplied via the supply air duct 9 can be conditioned in the desired manner by an air conditioning unit not shown with regard to temperature, air humidity and purity (e.g. by means of filters) to achieve reproducible test results in this way.

The brake dust and/or the brake dust particles are—via the exhaust air duct 10—guided to the actual measuring point (at A), which is located within the exhaust air duct 10 and on which the extraction unit 6 is provided. There the particles are picked up and guided to the particle measuring device 8 via, e.g., a heated hose 7. The particle measuring device 8 can be a well-known device as used, for example, for the measurement of exhaust gas. The number of particles and the size of particles are recorded by the particle measuring device 8.

The extraction unit 6, in turn, can be designed in an appropriate manner to extract the brake dust particles from the airflow flowing through the exhaust air duct 10.

To achieve the desired dilution effect within the exhaust air duct 10, by which, amongst others, the formation of clumping or conglomerates of the brake particles is to be prevented, the dimensions of the exhaust air duct 10 should be selected accordingly. This relates, in particular, to the length of the exhaust air duct 10 between the brake 3 to be tested and the measuring point B, as well as the cross-sectional area of the exhaust air duct 10. For example, the distance between the rotation axis of the brake 3 to be tested and the measuring point (at B) should amount to 10 to 20 times the diameter of the exhaust air duct 10. Should the exhaust air duct 10 be rectangular, then the side length of the longer edge is to be chosen for the calculation of the distance between the rotation axis of the brake to be tested and the measuring point B. The cross section of the exhaust air duct 10 should—at least at its inlet on the housing 11—not be smaller than 70% of the diameter of the brake disc of the brake 3 to be tested.

1-14. (canceled)

15. A device for measuring and detecting brake dust particles, the device comprising:
a housing configured to define a brake mount space for installation of a brake to be tested;
a fan system with a supply air duct and an exhaust air duct each connected to the brake mount space, the fan system configured to guide an airflow through the brake mount space;
an extraction unit arranged within the exhaust air duct and configured to pick up brake dust particles;
a particle measuring unit configured to measure a number and/or a size of the brake dust particles; and
a conveying unit configured to guide and convey the brake dust particles from the extraction unit to the particle measuring unit.

16. The device of claim 15, further comprising a brake mount arranged within the brake mount space and configured to mount the brake to be tested.

17. The device of claim 15, wherein the extraction unit is arranged within the exhaust air duct such that a flow path of the airflow has a predefined length from the brake to be tested to the extraction unit.

18. The device of claim 15, wherein a length of a flow path of the airflow and a distance between a rotation axis of the brake to be tested and the extraction unit depends on a size of a cross-section of the exhaust air duct.

19. The device of claim 15, wherein an outlet of the supply air duct provided on the housing and an inlet of the exhaust air duct provided on the housing are arranged opposite to each other.

20. The device of claim 15, wherein a distance between an inlet of the exhaust air duct and of the extraction unit corresponds to at least 5 times a diameter or a greatest diagonal of a cross-section of the exhaust air duct.

21. The device of claim 15, wherein a distance between an inlet of the exhaust air duct and of the extraction unit corresponds to at least 10 times a diameter or a greatest diagonal of a cross-section of the exhaust air duct.

22. The device of claim 15, wherein a distance between an inlet of the exhaust air duct and of the extraction unit corresponds to at least 20 times a diameter or a greatest diagonal of a cross-section of the exhaust air duct.

23. The device of claim 15, wherein the brake mount is encased by a measuring housing forming the housing and so as to define the brake mount space.

24. The device of claim 15, wherein the extraction unit has an extraction point within the exhaust air duct of the fan system, and wherein the extraction point is connected to the particle measuring unit via the conveying unit.

25. The device of claim 15, wherein the particle measuring unit is further configured to measure particles in diesel exhaust gases.

26. The device of claim 15, wherein the conveying unit has a pipe or hose-shaped conduit.

27. The device of claim 26, wherein the conduit connects the extraction unit to the particle measuring unit.

28. A brake test stand, comprising:
a brake mount configured to mount a brake to be tested;
a driving device configured to apply a brake load to the brake;
measuring units configured to record test and measuring parameters of the brake; and
a device comprising:
a housing configured to define a brake mount space for installation of the brake;
a fan system with a supply air duct and an exhaust air duct each connected to the brake mount space, the fan system configured to guide an airflow through the brake mount space;
an extraction unit arranged within the exhaust air duct and configured to pick up brake dust particles;
a particle measuring unit configured to measure a number and/or a size of the brake dust particles; and
a conveying unit configured to guide and convey the brake dust particles from the extraction unit to the particle measuring unit.

29. The brake test stand of claim 28, wherein the device is an integral component of the brake test stand.

30. A method of measuring and detecting brake dust particles, the method comprising:
mounting a brake to a brake mount, the brake mount being part of a housing that defines a brake mount space for installation of the brake;
applying a brake load to the brake;
recording test and measuring parameters of the brake;
guiding an airflow through the brake mount space via a fan system having a supply air duct and an exhaust air duct each connected to the brake mount space;
picking up brake dust particles via an extraction unit arranged within the exhaust air duct;
measuring a number and/or a size of the brake dust particles via a particle measuring unit; and
guiding and conveying the brake dust particles from the extraction unit to the particle measuring unit.

31. The method of claim 30, further comprising correlating measuring results of the particle measuring unit with the test and measuring parameters of the brake.
